(19) United States
(12) Patent Application Publication
(10) Pub. No.: US 2008/0109299 A1
(43) Pub. Date: May 8, 2008

(54) Multi-tiered career progression system and method

(75) Inventors: Sameer Khetarpal, Delhi (IN); Navanit Samaiyar, Gurgaon (IN)

Correspondence Address: KENYON & KENYON LLP, ONE BROADWAY, NEW YORK, NY, 10004, US

(73) Assignee: Genpact Global Holdings SICAR Sarl

(21) Appl. No.: 11/593,939

(22) Filed: Nov. 6, 2006

(51) Int. Cl. G06F 17/30

(52) U.S. Cl. 705/11

(57) ABSTRACT

The present invention pertains to the computerized systems and methods for processing and evaluating employee career advancement in a multi-tiered environment, defining a career path or job advancement structure within a company. Each tier may be associated with seniority and skills requirements. The promotion decision is electronically evaluated against the tier requirements for the next higher tier, or against the requirements for the tier at which the employee currently sits. If the employee has the requisite seniority, as required by (1) the next higher tier above the employee's current tier, or (2) the current tier, respectively, and the employee has all of the required skills for that tier, then the employee may be promoted to the next higher tier and may be assigned a particular job associated with the higher tier.

### COPYRIGHT

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND

The present invention relates generally to systems and methods for career progression and more specifically to systems and methods for career progression using a multi-tiered career progression model.

Today, companies are focusing more than ever on employee retention. One major reason for this focus is that companies lose money and productivity when experienced employees leave and new employees must be trained. On the job training can provide the employees with company-specific skills that increase the employees' productivity. When employees exit a company, the company must hire and train new employees or train existing employees in the particular tasks formerly performed by the exiting employees. The longer an employee spends performing a particular job-related task, the more efficient that employee becomes at the task. While new employees are being trained, their productivity, and hence the productivity of the company as a whole, suffers. Thus, it is in a company's best interest to retain their existing employees with important job skills in order to increase the productivity and company's bottom line. Moreover, the knowledge gained by existing employees often constitutes trade secrets that the company needs to protect, and employees' departure puts these trade secrets at a higher risk of disclosure.

Several circumstances make retaining employees increasingly difficult. First, the path of career progression in many companies is often nebulous and arbitrary. Employees feel as though they have little control over their destiny in the company, whether they are obtaining the right skills at the right time and at the right level of performance in order to attain the next promotion. Many companies employ regular reviews and performance assessments to help an employee gauge how satisfactory his or her work performance has been, but the evaluation criteria of those reviews and the results of the assessments are often kept hidden from the employees. Without clear understanding of the levels of promotions and associated job skills and other requirements, employees often lose confidence that their hard work will be rewarded with promotions. As a result, employees flock to rapidly growing, smaller companies where those employees feel that they are more likely to be promoted as the company hires greater numbers of lower level employees.

Second, employees may sometimes perceive that promotion in the company is tied more to the intangible factors unrelated to the employees' performance, such as promotions based on unrelated social ties or some other preferential treatment. Without uniform methodology to contradict and repudiate this perception, employees may become increasingly disillusioned in their job and the company in general by the expectations that their hard work could be undermined by another individual who receives a promotion on grounds other than that person's job performance and key job skills.

Third, a dearth of available higher-level positions makes promotions less certain. As the baby boomer generation retires increasingly later in life, upward mobility in a company is hampered. This concept, popularly known as the gray ceiling, could also make some employees fearful that their hard work will go unrewarded.

Therefore, there is a need for a computerized system and method that provides a systematic and automated job evaluation methodology and maps out the career development path within a company as a multi-tiered structure, where the skills necessary for each level are predefined and the advancement (promotion) criteria may be dependent on the employee's acquisition and retention of those job skills.

### BRIEF DESCRIPTION OF THE DRAWINGS

FIG. 1 depicts an exemplary system in accordance with one embodiment of the present invention.

FIGS. 2a and 2b depict flowcharts of illustrative career advancement evaluation steps in accordance with several embodiments of the present invention.

FIG. 3 shows an exemplary multi-tiered career progression model and associated skills in accordance with one embodiment of the present invention.

FIG. 4 depicts a flowchart of illustrative career advancement evaluation steps in accordance with another embodiment of the present invention.

FIGS. 5a, 5b, and 5c represent illustrative database tables that may be utilized in accordance with several embodiments of the present invention.

FIG. 6 depicts a flowchart of illustrative career advancement evaluation steps in accordance with yet another embodiment of the present invention.

FIGS. 7a and 7b represent exemplary database tables that may be utilized in accordance with several embodiments of the present invention.

### DETAILED DESCRIPTION

Generally, a multi-tiered career advancement system is presented that defines global sets of skills and other criteria that must be achieved and met by employees of a company in order to advance to the higher tiers in the company's career advancement structure. The system may map out the tiers of advancement for the entire company (or a particular operation within the company) and the skills required at each tier to be promoted to that tier. The system may also include an automated evaluation of whether an employee is to be promoted to the next higher tier, either when (1) the skills already obtained by the employee are compared against the skills required for the next higher tier, and if the employee has obtained the requisite skills, then the employee may be raised to the next higher tier or (2) the skills already obtained by the employee are compared to the skills necessary to fulfill the tier at which the employee currently sits, and if the skills requirement has been met, the employee may be raised to the next higher tier.

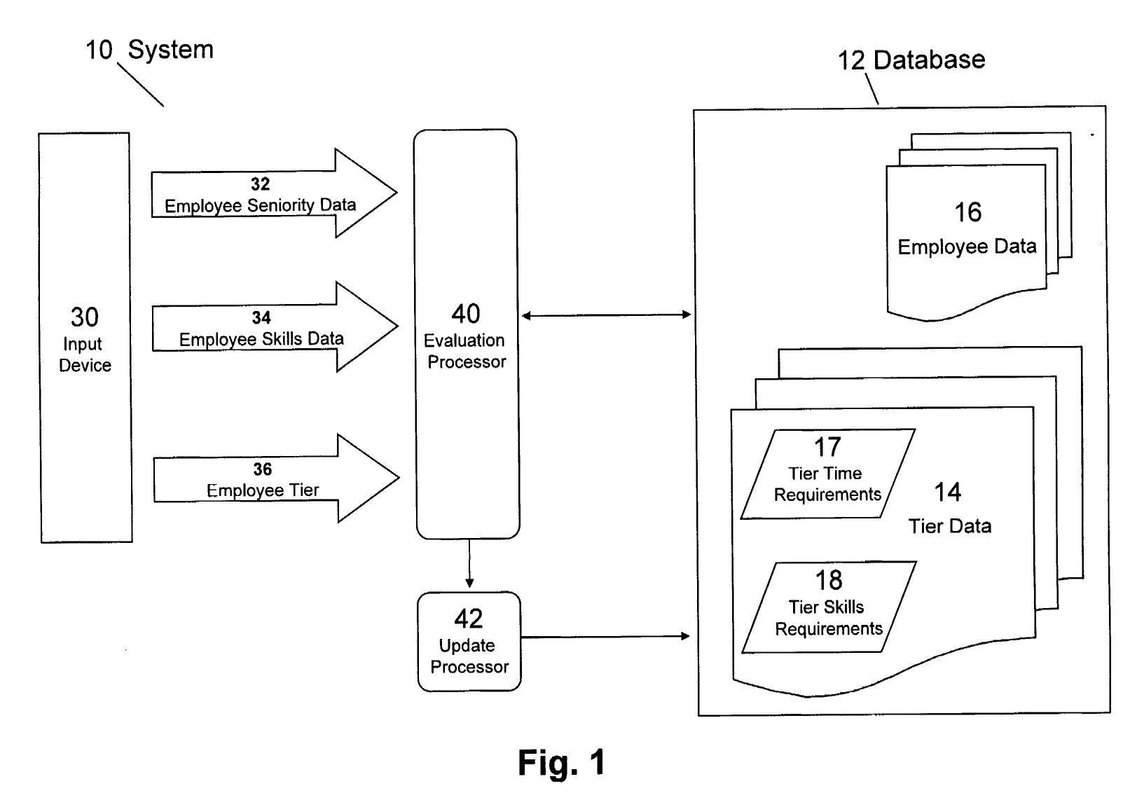

More specifically, FIG. 1 illustrates a system 10 with a database 12, input device 30, evaluation processor 40 in communication with input device 30 and database 12, and update processor 42 in communication with the database 12 and evaluation processor 40. The database 12 may store data related to multiple tiers of career advancement within the company (“Tier Data”) 14 and data related to the particular tier at which the employee sits (“Employee Tier Data”) 16. Tier data 14 may include data related to amounts of time required to be spent at the company to qualify for particular tiers (“Tier Time Requirements”) 17 and data related to skills required for particular tiers (“Tier Skills Requirements”) 18. Tier Time Requirements may include the time that an employee is required to have spent at the company (or at the job level in a particular tier) before the employee becomes eligible to advance to the respective higher tier. Tier Skills Requirements 18 may include the skills that an employee must acquire before the employee is eligible to advance to the respective higher tier. Employee Tier Data 16 may include the employee's current tier, the tier currently achieved by the employee. Database 12 may store the Tier Data 14 and Employee Tier Data 16 in various ways, including separate relational tables, in a single relational table, in separate objects, in a single flat file, various flat files or in a number of other known file types and data structures. Accordingly, the database 12 may be, but is not limited to, any appropriate database, including a relational database, object oriented database, file system database, or any combination of these databases. Likewise, database 12 may be, but is not limited to, a single unitary database or a distributed database. The specific implementation of database 12 is immaterial to this invention, but for illustrative purposes, database 12 will be depicted as a relational database.

In one embodiment, the input device 30 may provide an employee's data to the evaluation processor 40 so that the evaluation processor 40 may evaluate the employee. This data may include data related to the amount of time the employee has actually spent at the company (“Employee Seniority Data”) 32 (and/or the amount of time the employee has spent at a particular job associated with a particular tier) and data related to the skills the employee has acquired thus far (“Employee Skills Data”) 34. The method by which the input device 30 obtains Employee Seniority Data 32 or Employee Skills Data 34 may vary. For example, Input Device 30 may be in communication with database 12 or another database in which the employee's data is stored. Input device 30 may retrieve the data from the database and pass the information to the evaluation processor 40. Alternatively, the input device 30 may receive the employee's data from another computing device (not shown) over a computer network (not shown) and pass the employee's data to the evaluation processor. Still further, input device 30 may receive the employee's data from a user via any appropriate input method, including a mouse, keyboard, pen input, or the like.

The evaluation processor 40 may receive the Employee's data from the input device 30 and compare the Employee Seniority Data 32 against the Tier Time Requirements 17 for the next higher tier above Employee Tier Data 16 (the tier at which the employee currently sits). The evaluation processor 40 may also compare the Employee Skills Data against the Tier Skills Requirements for the next higher tier above Employee Tier Data 16. For example, Employee Seniority Data 32 and Tier Time Requirements 17 for the tier above the employee's current tier may be represented by integers. If the evaluation processor 40 determines that the Employee Seniority Data 32 is greater than or equal to the Tier Time Requirements 17 for the tier above the employee's current tier, then it may determine that the employee possesses sufficient seniority to move to the next higher tier. Also, the Employee Skills Data 34 and the Tier Skills Requirement 18 for the tier above the employee's current tier may be represented as sets of skills. If the evaluation processor 40 determines that the employee skills data 34 is equivalent to the Tier Skills Requirements 18 for the tier above the employee's current tier or that the first is a superset of the second, then the employee may possess sufficient skills to move to the next higher tier. If the employee possesses sufficient seniority and skills for the next higher tier, then the evaluation processor may determine that the employee may move to the next higher tier.

In an alternative embodiment, the evaluation processor 40 may compare the data from the input device 30 with the requirements for the tier at which the employee currently sits. Once the employee fulfills the requirements for the current tier, the employee may be promoted. The evaluation processor 40 may compare the Employee Seniority Data 32 with the Tier Time Requirements 17 for the tier at which the employee currently sits (Employee Tier Data 16). The Evaluation processor may also compare the Employee Skills Data 34 with the Tier Skills Requirements 18 for the tier at which the employee currently sits (Employee Tier Data 16). If the requirements are met, the employee may advance to the next higher tier.

The update processor may then update the Employee Tier Data 16 to reflect that the employee has been moved up to the next higher tier. The update processor may issue the appropriate calls to the database to effect the change in tier to the Employee Tier Data 16.

In one embodiment, the skills may be global skills defined for all employees at a particular job or job level, such that any employee that obtains the appropriate skills for a particular tier may move to the next level. Likewise, any employee who has worked with the company for the requisite time defined by the tier's tier time requirements may, if they have the requisite skills, move to that tier. In this way, an employee knows the requirements (skills, seniority, etc.) necessary to move to the next level in their career. Alternatively, the skills and requisite seniority or time requirements for a tier may be combined with other evaluation criteria, which may include without limitation such items as management or peer reviews, additional test scores and awards received by an employee.

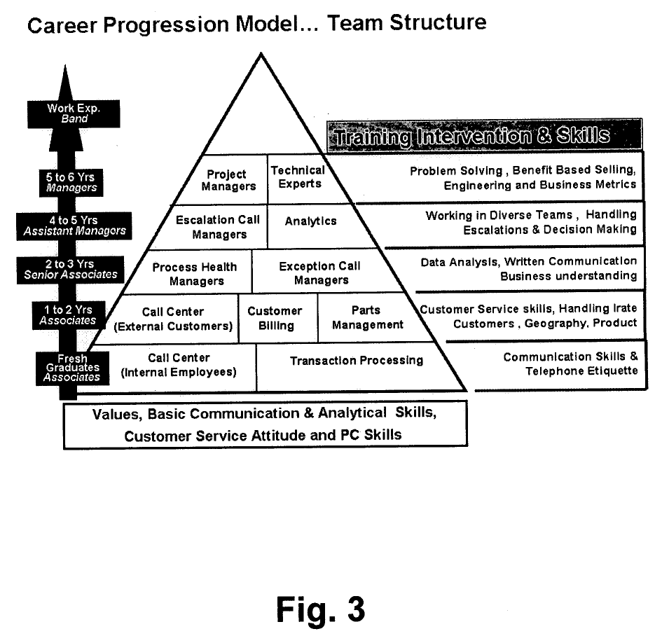

In one embodiment, as shown in FIG. 3, the present multi-tiered career advancement system may be implemented at a call center company branch or operation. As shown in FIG. 3, the left most portion 310 depicts multiple tiers within the call center operations, including the sample identifiers of Fresh Graduates, Associates, Senior Associates, Assistant Managers, and Managers. The left hand portion 310 also depicts the number of years that the employee must be with the company in order to attain each tier. The middle portion 320 represents particular jobs or roles that an employee may undertake at each tier (described below). In one embodiment, the right hand portion 330 depicts the skills that an employee must obtain in order to reach the particular tier level. For example, in order to attain the Assistant Manager tier, the employee must obtain the skills of Working in Diverse Teams, Handling Escalations, and Decision Making. In an alternative embodiment, the right hand portion 330 depicts the skills necessary for the employee to achieve at a particular tier before the employee will be promoted to the next higher tier. For example, an employee who is currently at the Assistant Manager position may need to obtain the skills of Working in Diverse Teams, Handling Escalations, and Decision Making in order to advance to the Manager tier.

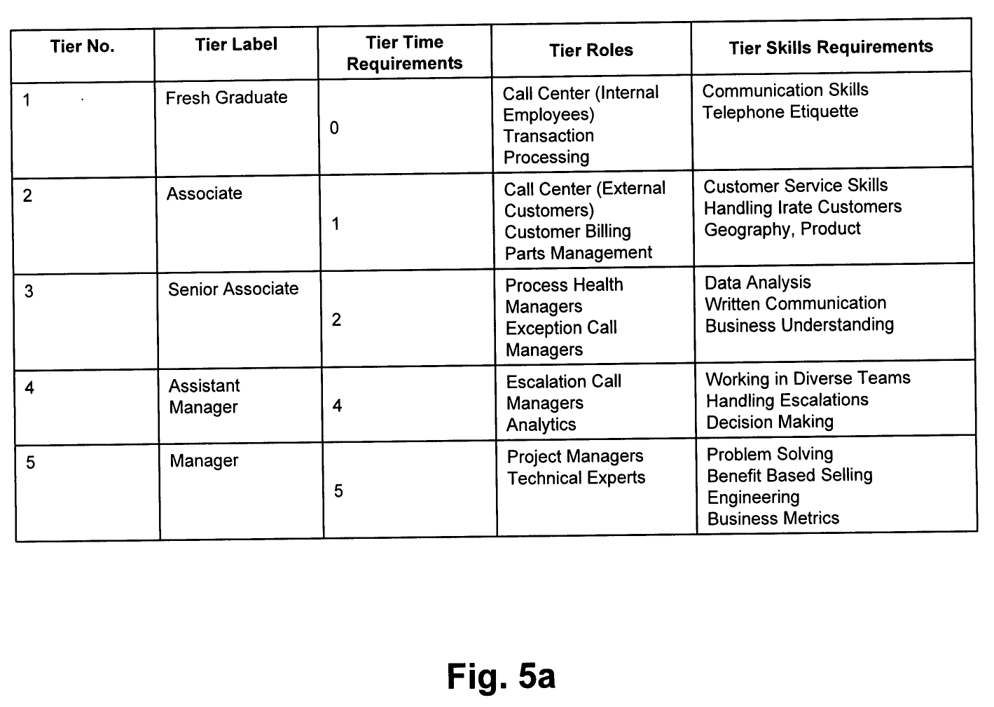

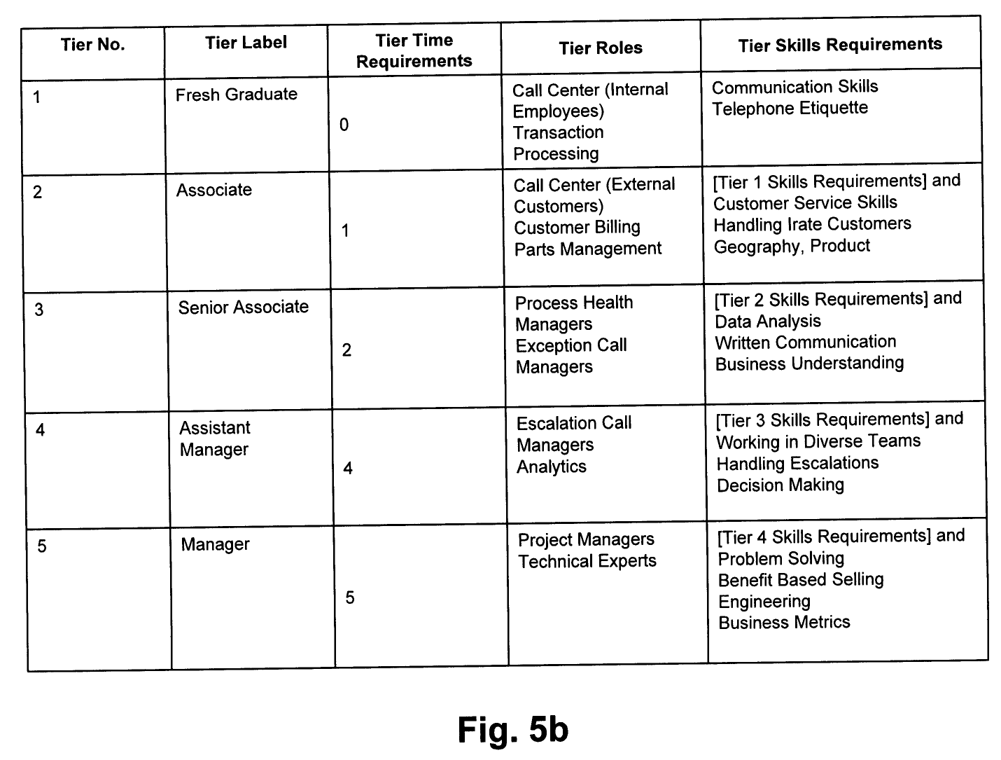

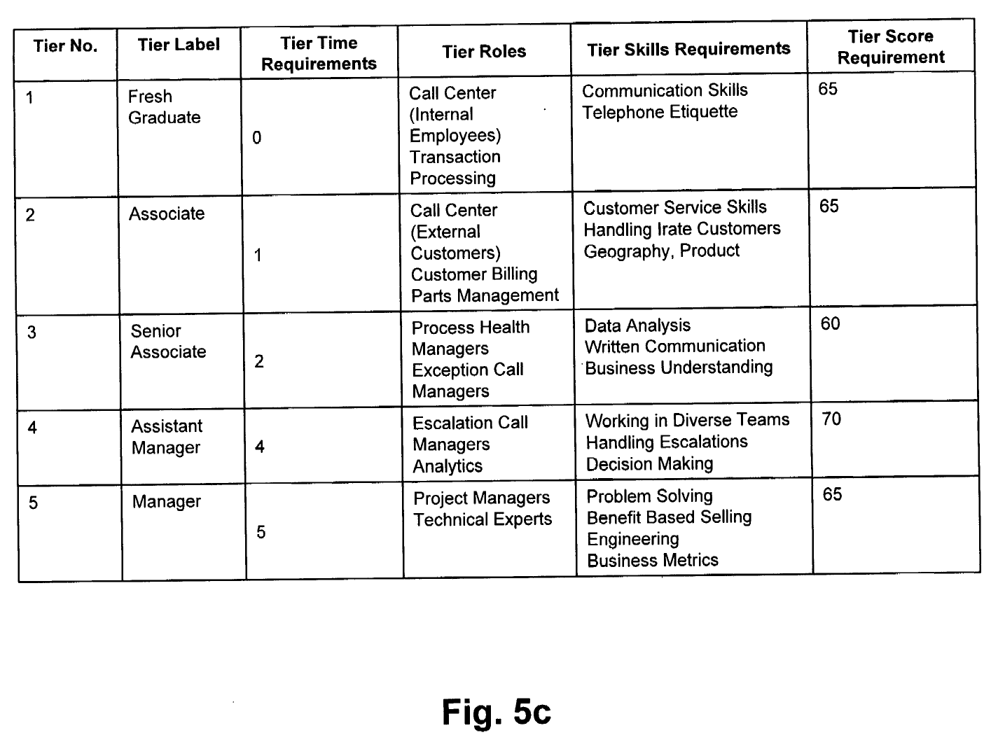

An exemplary database table that may be utilized with the current systems and methods is shown in FIG. 5a. The left most column represents the number of each respective tier. The second column represents the name of the tier. The third represents the number of years required before the employee will be considered for promotion to that tier. The fourth represents the particular roles (jobs) the employee may perform at that tier level. The fifth represents the skills that the employee must obtain to qualify for promotion to the tier.

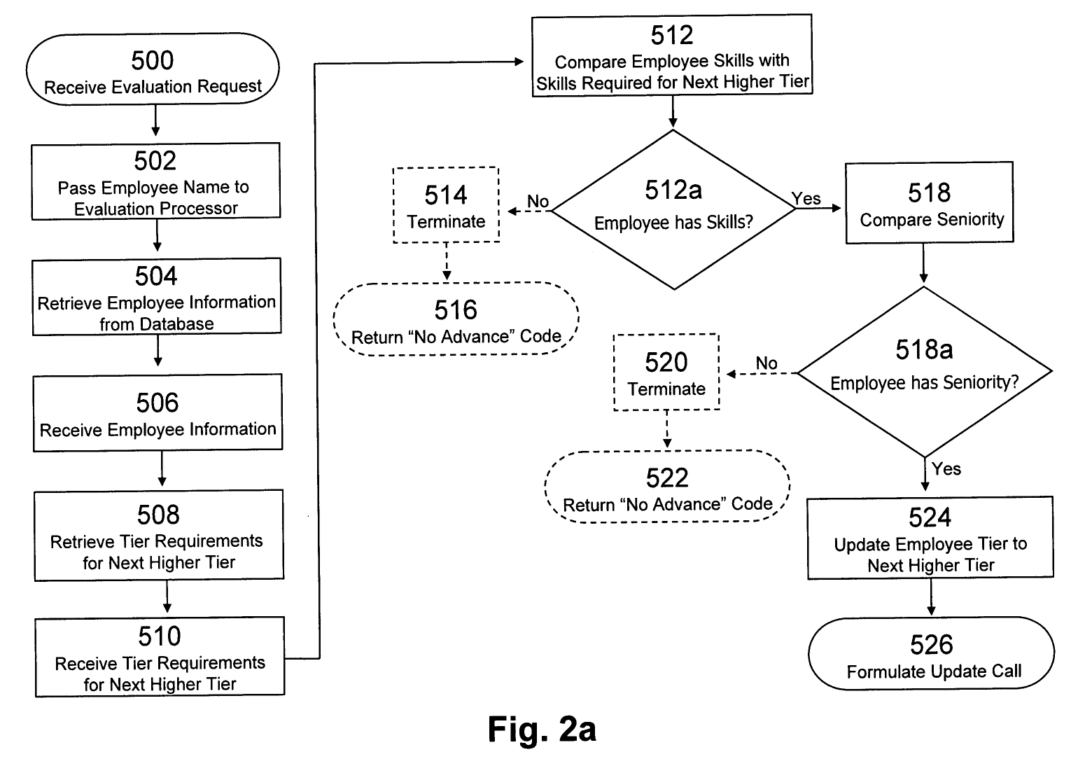

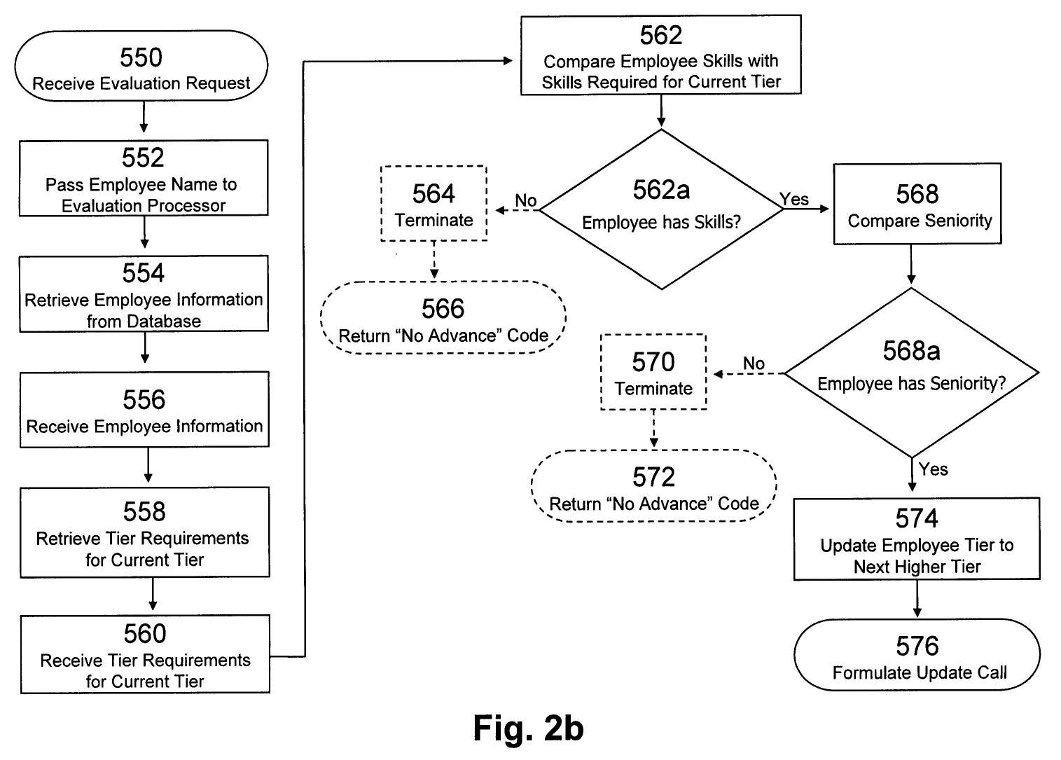

Turning to the flowchart of FIG. 2a to illustrate the steps that may be undertaken by the system of FIG. 1, the system may receive a request to evaluate whether the employee is ready to advance to the next level (block 500) from the input device 30. While this request may be an input from the user, an input over the network, or the like, it may also be an automatic input, such as a scheduled event on a calendar. Accordingly, the system 10 may be regularly invoked (such as once a month) to determine whether any of the employees is ready for promotion. The system 10 may cycle through all of the employees in database 12 and may request input from the input device 30.

The input device 30 may pass the employee's name (for example Xavier) to the evaluation processor 40 (block 502) and the evaluation processor 40 may retrieve the employee's information from the database 12 (block 504). To illustrate, the evaluation processor 40 may construct a database query and submit that query to the database. For example, if the database 12 is a relational database, the query may be formed using Structured Query Language, or SQL. The query may exist in the form “select EmployeeTier, EmployeeSkills, EmployeeSeniority from Employee_Information_Table where EmployeeName=Xavier.” In an illustrative example, the employee may have six years of seniority with the company and may have obtained the skills of Benefit Based Selling, Customer Retention, Engineering Budgeting, and Business Metrics. The evaluation processor 40 may receive the employee's information (block 506). For example, the data may be in a data structure that represents the row in the employee information table for the employee. This data structure may include fields for the employee's seniority (for example 6), the employee's skills (for example Problem Solving, Benefit Based Selling, Customer Retention, Engineering, Budgeting, and Business Metrics), and employee tier (for example 4 [representing the Assistant Manager tier]).

The evaluation processor may then retrieve the global requirements for one tier above the employee's current tier (block 508) (for example tier 5) in order to compare those requirements with the employee's data. For example, the evaluation processor 40 may again formulate an SQL query, this time of the form “select TierSkillsRequirements, TierTimeRequirements from Tier_Information_Table where TierNo=5.” The evaluation processor 40 may receive the response from the database 12 (block 510). For example, the data may be in a data structure. For example, the data structure may include a string field for the TierSkillRequirements field (for example Problem Solving, Benefit Based Selling, Engineering, and Business Metrics) and TierTimeRequirement (for example 5, representing that the employee must have worked at the company for five years).

The evaluation processor 40 may then compare the employee's skills with the skills necessary for the next higher tier (for example tier 5) (block 512) to determine whether the employee has the requisite skills to advance to the next tier. The evaluation processor 40 may employ any appropriate comparison function to compare the two skills sets. For example, the evaluation processor 40 may employ a nested loop to check whether each skill in the employee's skills is found in the Tier Skills Requirements. If indeed each skill of the Tier Skills Requirements for tier 5 (block 512a) is found in the employee's skills, then the employee possesses the requisite skills necessary to advance to the next higher tier. If the employee possesses the requisite skills (block 512a), the evaluation processor 40 may then compare the Tier Time Requirements for tier 5 with the employee's seniority (block 518) to determine whether the employee has the requisite seniority (block 518a) to advance to the next tier. In the example, tier 5 requires five years of experience, and Xavier has worked with the company for six years. Therefore, the evaluation processor 40 may determine that the employee has the requisite skills and seniority to advance to the next level.

If the employee possesses the requisite skills and seniority (block 518a), the evaluation processor 40 may invoke the update processor to change the employee's tier (block 520). In the example, the employee's tier would be changed from 4 to 5. The update processor 42 may update the employee's tier (block 526). For example, the update processor may perform the database call to effect this change. For example, the update processor 42 may construct an SQL query of the form “update Employee_Information_Table set EmployeeTier=5 where EmployeeName=‘Xavier.’” In this way, the employee may be promoted to the next higher tier. In an alternative embodiment (not shown), other objective and subjective criteria may also be evaluated and included in the decisions whether the employee should be promoted. These factors may include, but are not limited to, management and/or peer reviews, the score on performance reviews, scores on reviews from other co-workers, numbers of clients obtained in the past year, total billing, number of cases disposed of in the past year, awards received by an employee and the like.

In an alternative embodiment, illustrated in FIG. 2b, the employee's data may be compared against the current tier at which the employee sits to determine whether the employee has obtained the requirements necessary at the current tier. The system may receive a request to evaluate whether the employee is ready to advance to the next level (block 550) from the input device 30.

The input device 30 may pass the employee's name (for example Xavier) to the evaluation processor 40 (block 552) and the evaluation processor 40 may retrieve the employee's information from the database 12 (block 554). For example, the evaluation processor 40 may construct a database query and submit that query to the database. For example, if the database 12 is a relational database, the query may be formed using Structured Query Language, or SQL. The query may exist in the form “select EmployeeTier, EmployeeSkills, EmployeeSeniority from Employee_Information_Table where EmployeeName=Xavier.” In an illustrative example, the employee may have six years of seniority with the company and may have obtained the skills of Benefit Based Selling, Customer Retention, Engineering Budgeting, and Business Metrics. The evaluation processor 40 may receive the employee's information (block 556). For example, the data may be in a data structure that represents the row in the employee information table for the employee. This data structure may include fields for the employee's seniority (for example 6), the employee's skills (for example Working in Diverse Teams, Handling Escalations, and Decision Making), and employee tier (for example 4 [representing the Assistant Manager tier]).

The evaluation processor may then retrieve the global requirements for the current tier at which the employee currently sits (block 558) (for example tier 4) in order to compare those requirements with the employee's data. For example, the evaluation processor 40 may again formulate an SQL query, this time of the form “select TierSkillsRequirements, TierTimeRequirements from Tier_Information_Table where TierNo=4.” The evaluation processor 40 may receive the response from the database 12 (block 560). For example, the data may be in a data structure. The data structure may include a string field for the TierSkillRequirements field (for example Working in Diverse Teams, Handling Escalations, and Decision Making) and TierTimeRequirement (for example 4, representing that the employee must have worked at the company four years).

The evaluation processor 40 may then compare the employee's skills with the skills necessary for the tier at which the employee currently sits (for example tier 4) (block 512) to determine whether the employee has the requisite skills to advance to the next tier. The evaluation processor 40 may employ any appropriate comparison function to compare the two skills sets. For example, the evaluation processor 40 may employ a nested loop to check whether each skill in the employee's skills is found in the Tier Skills Requirements. If indeed each skill of the Tier Skills Requirements for tier 4 (block 562a) is found among the employee's skills, then the employee has obtained all of the skills for the current tier and may qualify to advance to the next higher tier. If the employee possesses the requisite skills (block 562a), the evaluation processor 40 may then compare the Tier Time Requirements for tier 4 with the employee's seniority (block 568) to determine whether the employee has the requisite seniority (block 568a) to advance to the next tier. In the example, tier 4 requires four years of experience, and Xavier has worked with the company for six years. Therefore, the evaluation processor 40 may determine that the employee has the requisite skills and seniority to advance to the next level.

If the employee possesses the requisite skills and seniority (block 568a), the evaluation processor 40 may invoke the update processor to change the employee's tier (block 570). In the example, the employee's tier would be changed from 4 to 5. For example, the update processor 42 may perform the database call to effect this change (block 576). For example, the update processor 42 may construct an SQL query of the form “update Employee_Information_Table set EmployeeTier=5 where EmployeeName=‘Xavier.” In this way, the employee may be promoted to the next higher tier.

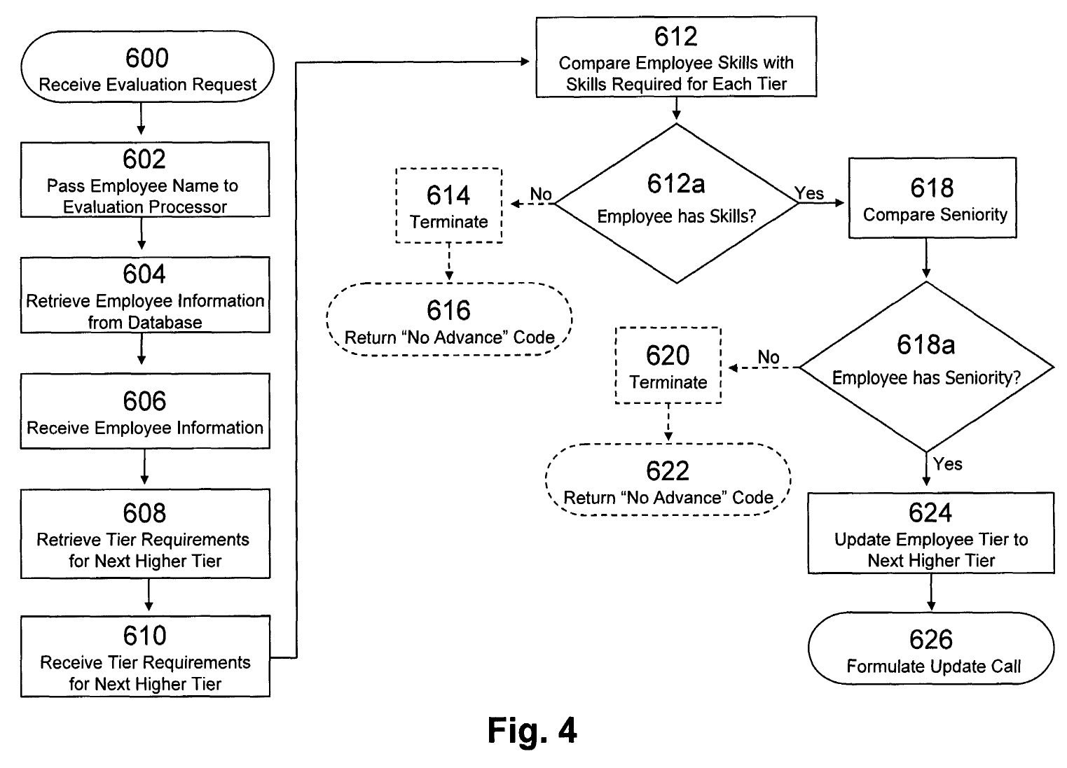

In an alternative embodiment, the Tier Skills Requirements for each tier may be cumulative, that is the Tier Skills Requirements for Tier No. x may include the Tier Skills Requirements for tier No. x-1. Turning to FIG. 4, the evaluation processor may retrieve the employee's seniority and skills from database 12 (block 604). The evaluation processor may receive the employee's seniority and skills (block 606). For example, the database may return seniority of six years for employee Xavier and skills of Communication Skills, Telephone Etiquette, Customer Service Skills, Handling Irate Customers, Geography, Product, Data Analysis, Written Communication, Business Understanding, Working in Diverse Teams, Handling Escalations and Decision Making. The evaluation processor may perform an iterative process to determine whether the employee possesses the requisite skills for the next higher tier above the employee's current tier (for example Tier. 4). The evaluation processor may determine tier by tier whether the employee possesses the skills required at each of those tiers (block 612). The evaluation processor may check whether each of the skills in the set of Tier Skills Requirements for each tier exists in the set of employee's skills (block 612a). In another alternative embodiment, the database may store the cumulative Tier Skills Requirements for each tier, as shown in FIG. 5b. In this case, the system may perform the steps of FIG. 2a and compare the employee's skills with the Tier Skills Requirements in the previous manner because each tier contains the full set of cumulative Tier Skills Requirements.

In an alternative embodiment, the cumulative evaluation may be performed to determine whether the employee has obtained the skills for the tier at which the employee currently sits. If the employee has obtained the necessary requirements for the current tier, the employee may be promoted to the next higher tier.

In another alternative embodiment, each tier may be associated with roles (jobs) to be performed at the tier level. The database may store the roles, as shown in column 4 of FIG. 5a. Updating the employee's tier to the next higher tier may be accompanied by updating the employee's role to be one of the roles associated with the next higher tier.

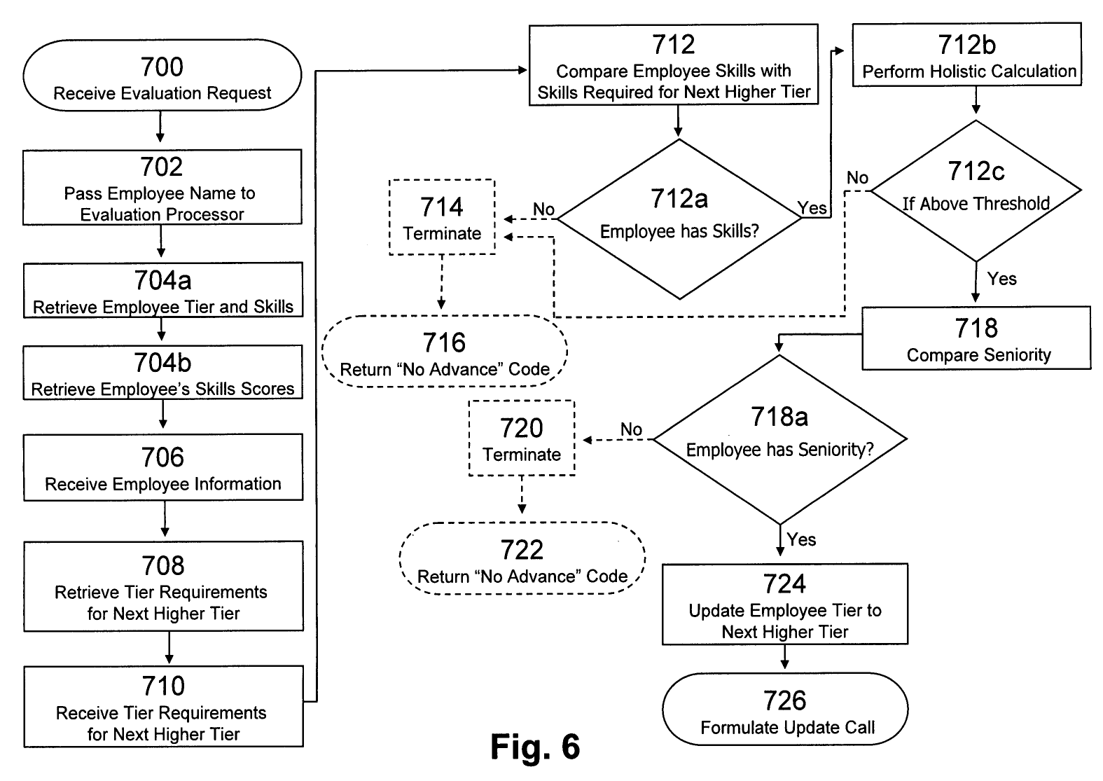

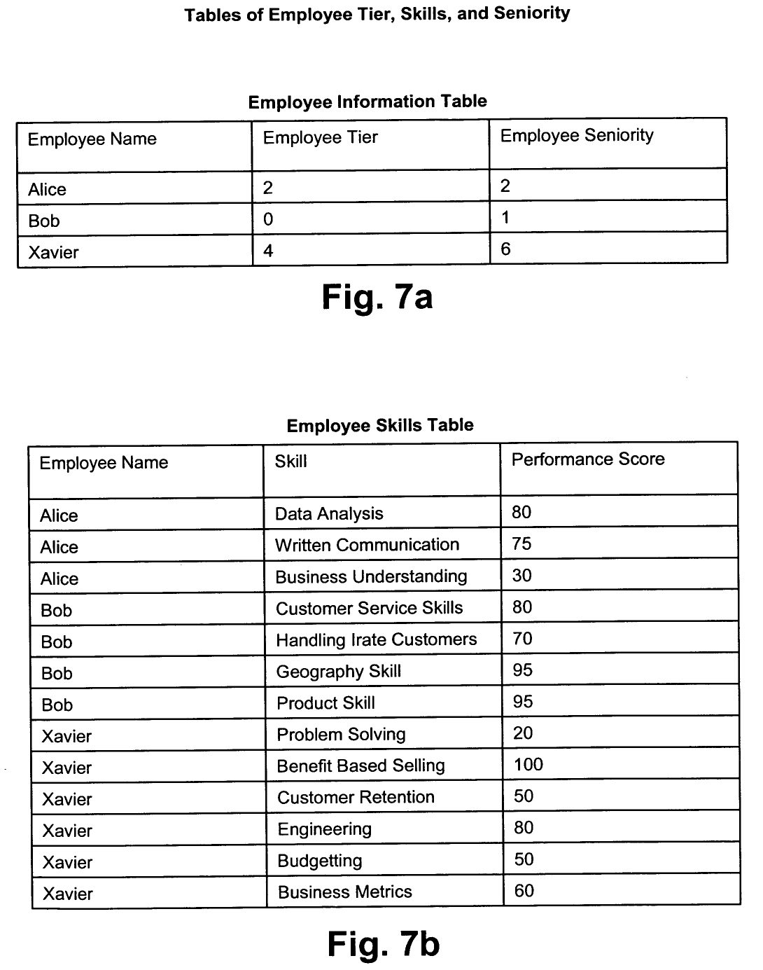

In yet another embodiment, the evaluation processor, in determining whether the employee possesses the requisite skills for the next higher tier, may evaluate the employee in a holistic manner instead of simply comparing the employee's skill set with the set of Tier Skills Requirements for the next higher tier. Holistic evaluation may involve associating scores to the employee skills and incorporating the scored skills into the comparison of the skills sets. In this manner, an employee who excels at a particular skill may counteract a poorer score in another skill, and an employee who performs poorly in a particular skill may not advance despite possessing some acumen in all of the relevant skills. An exemplary embodiment of this process is shown in FIG. 6. The evaluation processor may retrieve the employee skills and seniority for the employee (block 704). Exemplary database tables storing the skills and scores, as well as the employee's seniority and tier information are shown in FIGS. 7a and 7b. The evaluation processor may retrieve the employee's tier, skills, scores, and seniority. The first step may retrieve the employee's tier and skills (block 704a) and the second may retrieve the employee's scores in the skills (block 704b). Illustratively, the evaluation processor may accomplish this by formulating two SQL queries. The first may retrieve the tier and seniority from the Employee_Information_Table. For example, the first query may be “select EmployeeTier, EmployeeSeniority from Employee_Information_Table where EmployeeName=‘Xavier.’” The second query may retrieve the employee's skills and respective scores from the Employee_Skills_Table table and may be of the form “select Skill, Score from Employee_Skills_Table where EmployeeName=‘Xavier.’” The evaluation processor may receive the employee data from the database (block 706). The evaluation processor may then receive the tier data for the next higher tier from the employee's current tier (block 708). The database may include data denoting what holistic score is needed to attain the respective tier (“Tier Score Requirement”), as shown in FIG. 5c. The evaluation processor may formulate the SQL query “select TierSkillsRequirements, TierTimeRequirements, TierScoreRequirement from Tier_Information_Table where TierNo=5.” The evaluation processor may receive the data back from the database (block 710).

The evaluation processor may then compare the employee's skills and scores against the Tier Skills Requirements and Tier Score Requirement (block 712) to determine whether the employee possesses the requisite skills to attain the next higher tier. The evaluation processor may compare the Tier Skills Requirements for the next higher tier (for example tier 5) above the employee's current tier against the employee's skills. For example, the Tier Skills Requirements may be Problem Solving, Benefit Based Selling, Engineering, and Business Metrics and the employee's skills may be Problem Solving, Benefit Based Selling, Customer Retention, Engineering, Budgeting, and Business Metrics. If the employee possesses the requisite skills for the next higher tier (712a), then the evaluation processor may perform a holistic calculation that takes into account, at least in part, the scores for the relevant skills (block 712b). For example, the evaluation processor may take the average of the scores of the relevant employee's skills. For example, the scores may be (referring to FIG. 7b), 20 (Problem Solving), 100 (Benefit Based Selling), 80 (Engineering), and 60 (Business Metrics). Averaging these scores may result in a average score of 65. If the results of the holistic calculation are above a threshold (block 712c), the evaluation processor may move to the next criteria. For example, the minimum score for tier 5 is 65. The average score was 65, so the employee may pass the skills requirement criteria. The evaluation processor may then check the employee's seniority (block 718) and if the employee has the requisite seniority (block 718a), then the evaluation processor may update the employee's tier to the next higher tier (tier 5) (block 720).

It is contemplated that other holistic evaluation metrics may be used, including a summation of the employee's skill scores (score₁+score₂+ . . . scoreₙ), or a weighted sum of the employee's skill scores where particular skills are weighted more heavily and account for a greater over-all percentage of the calculation (score₁*weight₁+score₂*weight₂+ . . . scoreₙ*weightₙ)

In yet another embodiment, the holistic evaluation may be performed to determined whether the employee has obtained the skills for the tier at which the employee currently sits. If the employee has obtained the necessary requirements for the current tier, the employee may be promoted to the next higher tier.

In other embodiments, the evaluation criteria may employ other criteria in addition to whether the employee has obtained the requisite skills and seniority in order to evaluate whether the employee should be promoted to the next higher tier. Other criteria include, but are not limited to, the score on performance reviews, scores on reviews from other co-workers, numbers of clients obtained in the past year, total billing, number of cases disposed of in the past year, awards received by an employee and the like. The set of criteria evaluated may also eliminate seniority. With each combination of operative criteria, the database may store the relevant information, and the evaluation processor may be configured to perform the necessary evaluation on the set of criteria to judge whether an employee has the relevant criteria to be moved to the next higher tier.

In one embodiment, the method and system of the present invention may be implemented on a computing platform containing a CPU, memory, and input device. The memory may store the necessary computer instructions to carry out the methods of the present invention. The memory may be solid state memory, such as flash ROM, CDROM, DVDROM, hard disk media, etc, or may be volatile, such as random access memory. The processor may be configured to execute the computer instructions in memory. The processor may be any conventional processor, such as available from Intel corporation, or may be a specialized processor adapted to perform the methods of the present invention, such as various embedded processors available in the market. The CPU and memory may be operably connected to transmit information back and forth to execute the instructions in the memory. The CPU may be operably connected to an input device to receive input from the user. The CPU may also be operably connected to a data store where the data for tier requirements, skills, and the like are stored relevant to the present invention. The data store, in one embodiment, may exist in the same location as the computer instructions for the present invention.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover all modifications, variations or equivalents that fall within the scope of the basic underlying principals disclosed and claimed herein.

What is claimed is:

1. An automated method for career advancement within a company comprising the steps of:
receiving data related to multiple tiers for career advancement within the company and data related to a particular tier at which an employee currently sits;
associating each tier with a data related to a time required to be spent at the company for that tier and a data related to one or more skills required for that tier;
receiving data related to an amount of time the employee has spent at the company and data related to one or more skills the employee has acquired; and
electronically evaluating whether the employee may advance to the higher tier among the multiple tiers, based at least in part on a comparison between the data related to the amount of time the employee has spent at the company and the data related to the time required to be spent at the company for the tier at which the employee currently sits and also based at least in part on a comparison of the data related to the one or more skills the employee has acquired and the data related to the one or more skills required for the tier at which the employee currently sits.

2. The method of claim 1-wherein the company comprises a call center operation.

3. The method of claim 1 wherein the company provides healthcare services.

4. The method of claim 1, further comprising the step of:
promoting the employee to a next higher tier, at least partially based on the results of the electronic evaluation step.

5. The method of claim 4, further comprising the steps of:
associating each tier with a data related to at least one employee role; and
promoting the employee to an employee role associated with the next higher tier.

6. The method of claim 5 wherein the at least one employee role is taken from the group consisting of Call Center (Internal Employees), Transaction Processing, Call Center (External Customers), Customer Billing, Parts Management, Process Health Managers, Exception Call Managers, Escalation Call Managers, Analytics, Project Managers, and Technical Experts.

7. The method of claim 1 wherein the multiple tiers comprise a tier for Fresh Graduates, a tier for Associates, a tier for Senior Associates, a tier for Assistant Managers and a tier for Managers.

8. The method of claim 1 wherein the one or more skills is taken from the group consisting of Communication Skills, Telephone Etiquette, Customer Service Skills, Handling Irate Customers, Geography Skills, Product Skills, Data Analysis, Written Communication, Business Understanding, Working in Diverse Teams, Handling Escalations, Decision Making, Problem Solving, Benefit Based Selling, Engineering, and Business Metrics.

9. A system for evaluating an employee's performance within a company comprising:
a database for storing data related to a plurality of tiers for career advancement within the company and for storing data related to a tier at which the employee currently sits, wherein each of the plurality of tiers is associated with a data related to an amount of time required to be spent at the company and a data related to one or more skills required for that tier;
an input device for receiving data related to an amount of time the employee has spent at the company and data related to one or more skills the employee has acquired;
an evaluation processor for evaluating whether the employee may advance to the next tier based at least in part on a comparison between the data related to the amount of time the employee has spent at the company and the data related to the amount of time required to be spent at the company and based at least in part on a comparison between the data related to the one or more skills the employee has acquired and the data related to the one or more skills required for the particular tier at which the employee sits; and
an update processor for promoting the employee to a next higher tier based at lest in part on the results provided by the evaluation processor.

10. The apparatus of claim 9 wherein the company comprises a call center operation.

11. The apparatus of claim 9 wherein the company provides healthcare services.

12. The apparatus of claim 9 wherein, each tier in the database is further associated with a data related to at least one employee job and the update processor promotes the employee to an employee job associated with the next higher tier.

13. The apparatus of claim 12 wherein the at least one employee job is taken from the group consisting of Call Center (Internal Employees), Transaction Processing, Call Center (External Customers), Customer Billing, Parts Management, Process Health Managers, Exception Call Managers, Escalation Call Managers, Analytics, Project Managers, and Technical Experts.

14. The apparatus of claim 9 wherein the plurality of tiers comprise a tier for Fresh Graduates, a tier for Associates, a tier for Senior Associates, a tier for Assistant Managers and a tier for Managers.

15. The apparatus of claim 9 wherein the one or more skills is taken from the group consisting of Communication Skills, Telephone Etiquette, Customer Service Skills, Handling Irate Customers, Geography Skills, Product Skills, Data Analysis, Written Communication, Business Understanding, Working in Diverse Teams, Handling Escalations, Decision Making, Problem Solving, Benefit Based Selling, Engineering, and Business Metrics.

16. An automated method for career advancement within a company comprising the steps of:
receiving data related to multiple tiers for career advancement within the company and data related to a particular tier at which an employee currently sits;
associating each tier with a data related to a time required to be spent at the company for that tier and a data related to one or more skills required for that tier;
receiving data related to an amount of time the employee has spent at the company and data related to one or more skills the employee has acquired; and
electronically evaluating whether the employee may advance to the higher tier based at least in part on a comparison between the data related to the amount of time the employee has spent at the company and the data related to the amount of time required to be spent at the company for the next higher tier above the employee's current tier, and based at least in part on a comparison between the data related to the one or more skills the employee has acquired and the data related to the one or more skills required for the next higher tier above the employee's current tier.

17. The method of claim 16 wherein the company comprises a call center operation.

18. The method of claim 16 wherein the company provides healthcare services.

19. The method of claim 16, further comprising the step of:
promoting the employee to a next higher tier, at least partially based on the results of the electronic evaluation step.

20. The method of claim 19, further comprising the steps of:
associating each tier with a data related to at least one employee role; and
promoting the employee to an employee role associated with the next higher tier.

21. The method of claim 20 wherein at least one employee role is taken from the group consisting of Call Center (Internal Employees), Transaction Processing, Call Center (External Customers), Customer Billing, Parts Management, Process Health Managers, Exception Call Managers, Escalation Call Managers, Analytics, Project Managers, and Technical Experts.

22. The method of claim 16 wherein the multiple tiers comprise a tier for Fresh Graduates, a tier for Associates, a tier for Senior Associates, a tier for Assistant Managers and a tier for Managers.

23. The method of claim 16 wherein the one or more skills is taken from the group consisting of Communication Skills, Telephone Etiquette, Customer Service Skills, Handling Irate Customers, Geography Skills, Product Skills, Data Analysis, Written Communication, Business Understanding, Working in Diverse Teams, Handling Escalations, Decision Making, Problem Solving, Benefit Based Selling, Engineering, and Business Metrics.

24. A system for evaluating an employee's performance within a company comprising:
a database for storing data related to a plurality of tiers for career advancement within the company and for storing data related to a tier at which the employee currently sits, wherein each of the plurality of tiers is associated with a data related to an amount of time required to be spent at the company and a data related to one or more skills required for that particular tier;
an input device for receiving data related to an amount of time the employee has spent at the company and data related to one or more skills the employee has acquired;
an evaluation processor for evaluating whether the employee may advance to the next tier based at least in part on a comparison between the data related to the amount of time the employee has spent at the company and the data related to the amount of time required to be spent at the company for the next higher tier above the employee's current tier and based at least in part on a comparison between the data related to the one or more skills the employee has acquired and the data related to the one or more skills required for the next higher tier above the employee's current tier; and
an update processor for promoting the employee to a next higher tier based on the results of the evaluation.

25. The apparatus of claim 24 wherein each tier in the database is further associated with a data related to at least one employee job and the update processor promotes the employee to at least one employee job associated with the next higher tier.

26. The apparatus of claim 25 wherein the at least one employee job is taken from the group consisting of Call Center (Internal Employees), Transaction Processing, Call Center (External Customers), Customer Billing, Parts Management, Process Health Managers, Exception Call Managers, Escalation Call Managers, Analytics, Project Managers, and Technical Experts.

27. The apparatus of claim 24 wherein the plurality of tiers comprise a tier for Fresh Graduates, a tier for Associates, a tier for Senior Associates, a tier for Assistant Managers and a tier for Managers.

28. The apparatus of claim 24 wherein the one or more skills is taken from the group consisting of Communication Skills, Telephone Etiquette, Customer Service Skills, Handling Irate Customers, Geography Skills, Product Skills, Data Analysis, Written Communication, Business Understanding, Working in Diverse Teams, Handling Escalations, Decision Making, Problem Solving, Benefit Based Selling, Engineering, and Business Metrics.
